(19) United States
(12) Patent Application Publication
(10) Pub. No.: US 2010/0251118 A1
(43) Pub. Date: Sep. 30, 2010

(54) HELP UTILITY WITH EXPANDED CONTENT DISPLAY

(76) Inventor: Michael L. Peterson, El Dorado, KS (US)

Correspondence Address: CHRISTOPHER P MAIORANA, PC;LSI Corporation, 24840 HARPER, SUITE 100, ST CLAIR SHORES, MI, 48080, US

(21) Appl. No.: 12/411,648

(22) Filed: Mar. 26, 2009

(51) Int. Cl. G06F 3/048

(52) U.S. Cl. 715/710

(57) ABSTRACT

A method of using a help utility user interface to facilitate data entry into a software application. The method includes receiving via the help utility user interface a first user input relating to a data field of the application software, storing the first user input in a data cell associated with the data field of the application software corresponding with a current item and receiving via the help utility user interface a second user input related to moving to another item. The help utility user interface presents an active data field for receiving the first user input for the current item, a first inactive field representing a previous item and a second inactive field representing a subsequent item.

### FIELD OF THE INVENTION

The present invention relates to data entry generally and, more particularly, to a method and/or apparatus for a help utility with expanded content display.

### BACKGROUND OF THE INVENTION

In a software application, there are times when a user needs to enter a series of data. The application can show the data fields to be entered as a list or a grid. However, the data entry is performed via a standard wizard. In the standard wizard, each row in the list (or grid) corresponds to a specific instance of a dialog box/page in the wizard.

In a conventional data entry wizard, the user can only see the data that is being entered for the active row. The user must finish the data entry for the current row in order to see the data from either a previous row or a next row. For a user to go backward or forward in the standard wizard, the user must finish entering the data for the current row.

### SUMMARY OF THE INVENTION

The present invention concerns a method of using a help utility user interface to facilitate data entry into a software application. The method includes receiving via the help utility user interface a first user input relating to a data field of the application software, storing the first user input in a data cell associated with the data field of the application software corresponding with a current item and receiving via the help utility user interface a second user input related to moving to another item. The help utility user interface presents an active data field for receiving the first user input for the current item, a first inactive field representing a previous item and a second inactive field representing a subsequent item.

The objects, features and advantages of the present invention include providing a method and/or apparatus for a help utility with expanded content display that may (i) allow a user to see data entered for a previous page while entering data in a current page, (ii) allow a user to see an upcoming page while entering data in a current page, (iii) allow a user to navigate through a sequence of pages by clicking on either navigation buttons or corresponding data fields, (iv) present a number of previous and a number of subsequent steps in a manner distinguishing the steps from the current step and/or (v) varying the manner in which the previous and subsequent steps are presented based upon distance from the current step.

### BRIEF DESCRIPTION OF THE DRAWINGS

These and other objects, features and advantages of the present invention will be apparent from the following detailed description and the appended claims and drawings in which:

FIG. 1 is a block diagram illustrating a system including a help utility with expanded content display in accordance with an example embodiment of the present invention;

FIG. 2 is a diagram illustrating an example display in accordance with an example embodiment of the present invention;

FIG. 3 is a block diagram illustrating a data grid to be filled based upon user input;

FIG. 4 is a block diagram illustrating an example page of a data entry help utility in accordance with an example embodiment of the present invention;

FIG. 5 is a block diagram illustrating another example page of a data entry help utility in accordance with an example embodiment of the present invention;

FIG. 6 is a block diagram illustrating still another example page of a data entry help utility in accordance with an example embodiment of the present invention; and

FIG. 7 is a block diagram illustrating yet another example page of a data entry help utility in accordance with an example embodiment of the present invention.

### DETAILED DESCRIPTION OF THE PREFERRED EMBODIMENTS

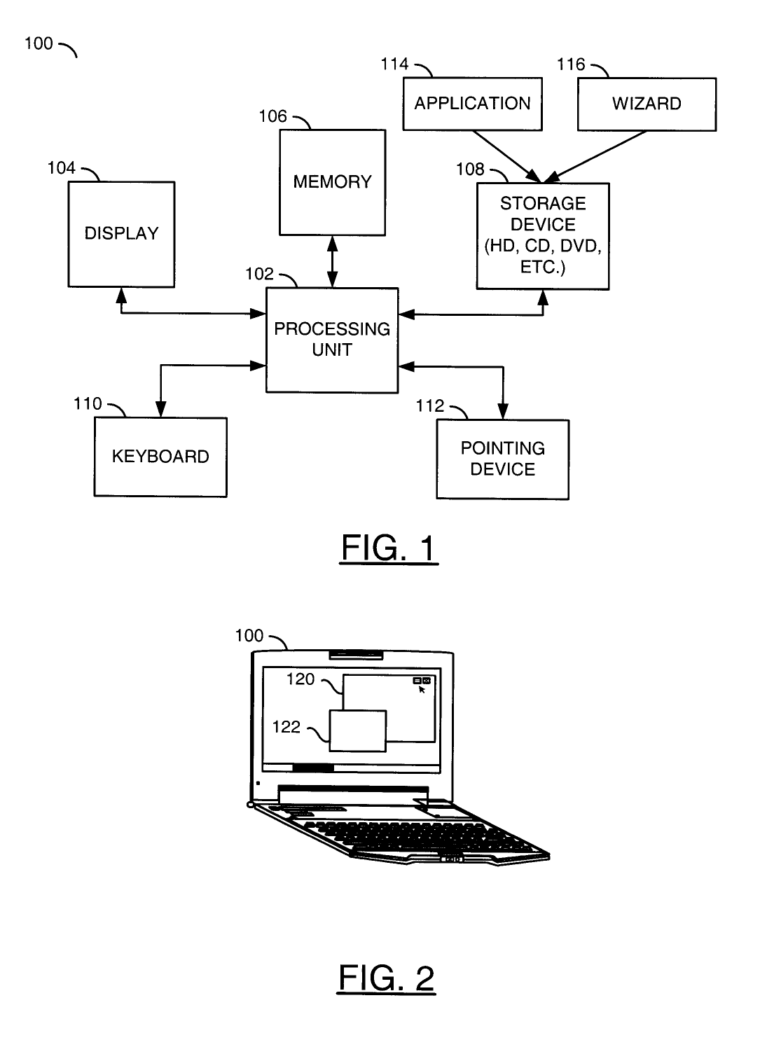

Referring to FIG. 1, a block diagram of a system 100 is shown. The system 100 generally comprises a computer system in which a data entry help utility in accordance with an embodiment of the present invention may be implemented. In one example, the system 100 may comprise a block 102, a block 104, a block 106, a block 108, a block 110, a block 112, a block 114 and a block 116. The block 102 may be implemented as a processing unit (e.g., a microprocessor, central processing unit, etc.). The block 104 may be implemented as a display (e.g., monitor, flat screen, LCD, etc.). The block 106 may be implemented as a system memory. In one example, the memory 106 may comprise one or more types of memory (e.g., random access memory (RAM), read only memory (ROM), flash, etc.). The block 108 may be implemented as one or more storage devices. In one example, the block 108 may comprise one or more types of storage media (e.g., hard drive (HD), compact disc drive (CD), digital versatile disc (DVD), etc.). The block 110 may be implemented, in one example, as a keyboard. The block 112 may be implemented, in one example, as a pointing device (e.g., mouse, trackball, touch pad, stylus, etc.).

In one example, the storage device 108 may contain an application 114 and a data entry help utility 116. The application 114 may be configured to present a list or grid representation of data to be entered by a user. In one example, the help utility 116 may comprise an interactive help utility that may be configured to guide a user through each step of a particular task, such as testing an application. In one example, the help utility 116 may be implemented within the application 114. In one example, the help utility 116 may comprise an application wizard. The help utility 116 may be configured in accordance with an example embodiment of the present invention to assist the user with the task of entering the data requested by the application 114. The application 114 and the help utility 116 may be implemented as software programs that may be run using the system 100. For example, the application 114 may comprise processor executable instructions for performing predetermined operations based upon data entered by a user. The help utility 116 may comprise processor executable instructions for controlling the system 100 to facilitate entry of the data by the user.

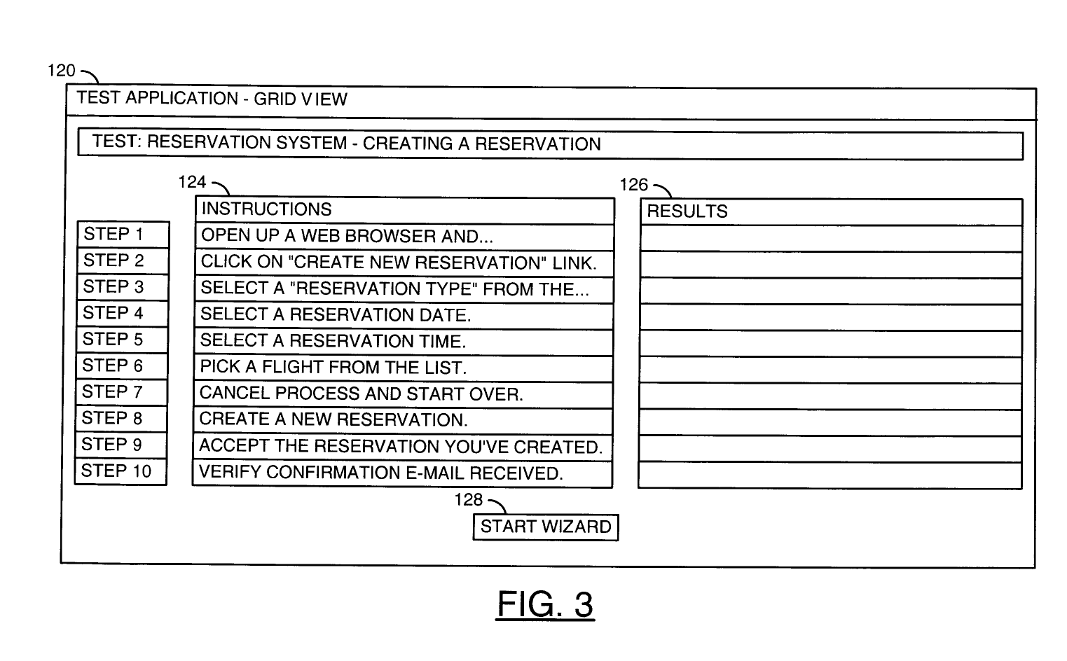

Referring to FIG. 2, a block diagram is shown illustrating an example display generated by the application 114 and the help utility 116. In one example, the system 100 may be implemented as a portable computer (e.g., a laptop computer, a notebook computer, etc.). The system 100 may include a data entry help utility 116 in accordance with an example embodiment of the present invention. In one example, the application 114 may present an image 120 on the display of the portable computer. The image 120 may include a list (or grid) indicating data to be entered by a user (described in more detail in connection with FIG. 3). The image 120 may be displayed, in one example, as a window or a frame.

In one example, the data entry help utility 116 may be implemented as a dialog box-based application help utility. The help utility 116 may display a dialog box (or page) 122. The dialog box 122 may be displayed on top of the image 120. In one example, the dialog box 122 may be implemented as an overlay, a separate window, a separate frame, or some other appropriate image. In another example, the image 120 may comprise a browser window generated by a web page application. Instead of the dialog box 122 being generated in a separate window, the dialog box 122 may comprise a next state of an existing browser window. For example, when the user on a web page clicks the button for the wizard, the web page may change to a first “screen” of the wizard. Each subsequent click, moving from one record to another, may result in a new page being loaded. The general layout of the page while progressing through the help utility may be similar to the layout described below.

Referring to FIG. 3, a diagram is shown illustrating an example application page 120. In one example, the page 120 may be generated by a test application for testing a reservation system. In one example, the test application may be configured to test specific portions of the reservation system. For example, the page 120 shown in FIG. 3 illustrates an example of a grid view for testing a portion of the reservation system for creating a reservation.

In one example, the user may currently be working with an application that contains test case data. When the user selects a test case, the user may be presented with a list of steps that need to be executed to complete the test case. The steps may be presented in a grid view that shows a number of fields as a first column 124, and the values in each cell as a second column 126. In addition to the grid, a button 128 may be presented which starts the help utility application 116 when selected (e.g., with a mouse click, etc.).

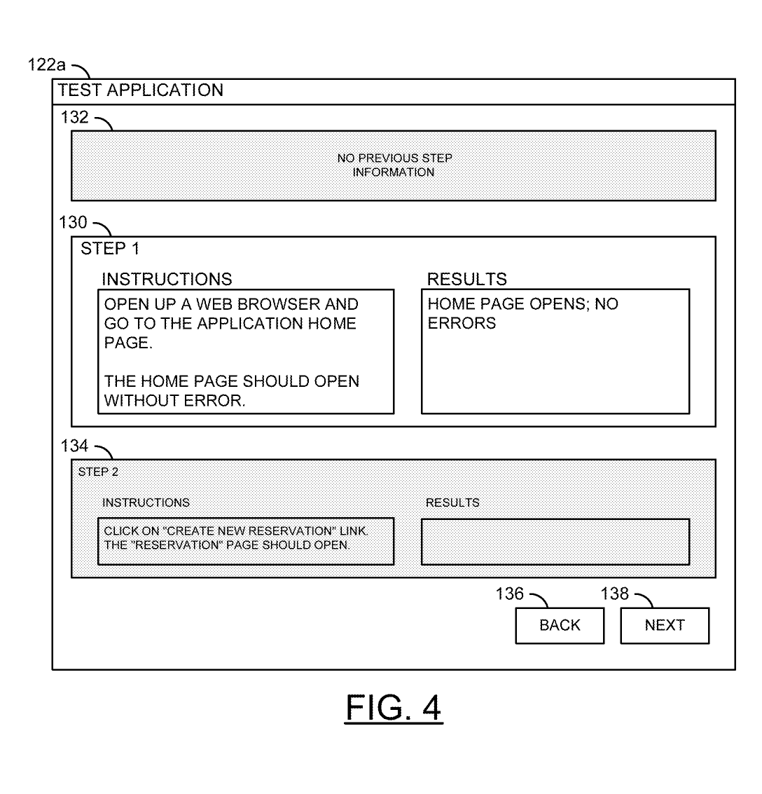

Referring to FIG. 4, a diagram is shown illustrating an example of an initial dialog box that may be presented when the help utility 116 is started. The help utility 116 may be implemented as a dialog box-based application. The help utility 116 may be configured to present a sequence of dialog boxes (or pages) 122a-122n, where each dialog box corresponds to a field in the list presented by the application 114. For example, each dialog box may correspond to a respective row (e.g., Step) in the grid contained in the image 120.

In one example, the initial dialog box 122a may comprise a box 130, a box 132, a box 134, a box 136 and a box 138. The box 130 may comprise an active area (or field) of the dialog box 122a. The boxes 132 and 134 may comprises inactive areas of the dialog box 122a. The boxes 136 and 138 may be implemented as buttons that may be configured to control movement through the sequence of dialog boxes presented by the help utility 116. In one example, the box 136 may be implemented as a “Back” button for moving backward through the sequence and the box 138 may be implemented as a “Next” button for moving forward through the sequence.

The box 130 may show more information (e.g., instructions, etc.) to the user than may have actively been entered and modified. The boxes 132 and 134 of the dialog box 122a generally expand the information presented to the user by the help utility 116. For example, when the user of the application program 114 is to enter a list of data, or is to modify the values of a list of items, and the program 114 provides the help utility 116 to modify the data, the box 132 may show information from items immediately before a current item and the box 134 may show items from immediately after the current item.

In one example, the box 132 and the box 134 may be shown in a manner (e.g., as ghosted items, greyed items, etc.) indicative of a non-active status. The user may modify the data for the current item. In addition, the user may also see the data that was entered for the previous item. In one example, the user may want to see what may be expected, or what has been entered previously, for the next item. For example, the box 130 may show the instructions for the current step in a test process (e.g., Step 1), and the results entered by the user. The box 132 may indicate that there is no previous step information because the dialog box 122a is the first dialog box in the sequence presented by the help utility 116. The bottom box 134 may show the instructions and results fields for a next step in the test process (e.g., Step 2).

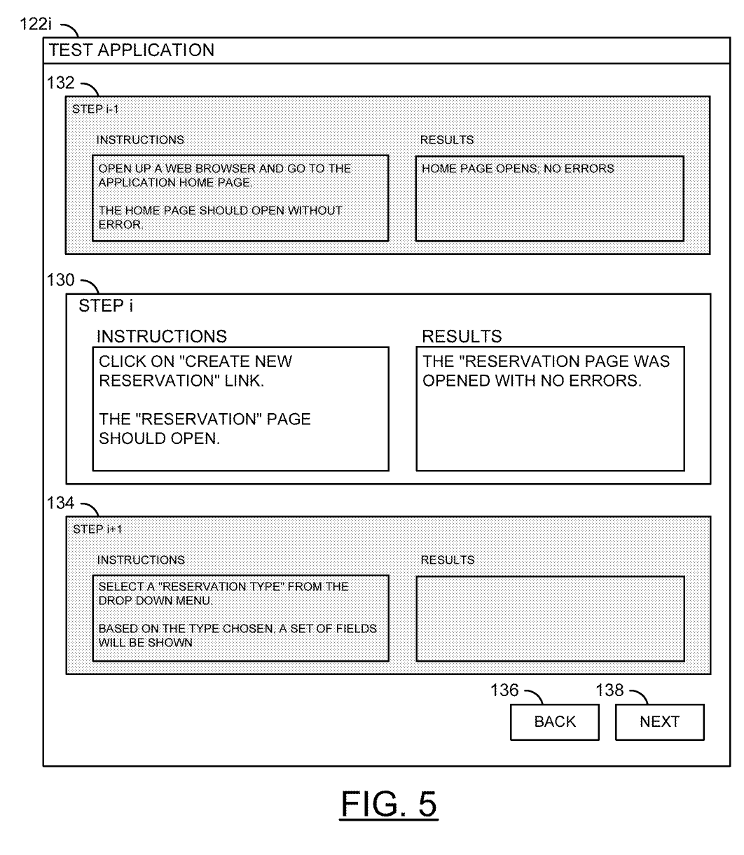

Referring to FIG. 5, a diagram is shown illustrating an example dialog box 122i. The dialog box 122i may be presented in response to the user having filled in the results for the current item (e.g., Step 1) in the dialog box 122a, and clicked either the “Next” button 138 or anywhere in the box 134. The information that was in the active box 130 of the dialog box 122a is generally moved to the box 132. The active box 130 presents the instructions and results box for the new current step (e.g., Step 2). The box 134 may be updated to show information for a next step in the test process (e.g., Step 3). In general, the box 130 shows information for a current item (e.g., Step i), the box 132 shows information for a previous item (e.g., Step i−1) and the box 134 shows information for a next item (e.g., Step i+1). The boxes 132 and 134 may be considered “read-only”. In general, clicking anywhere in the boxes 132 or 134 may have a similar effect to clicking the “Back” or “Next” button, respectively (e.g., depending on the box that was clicked).

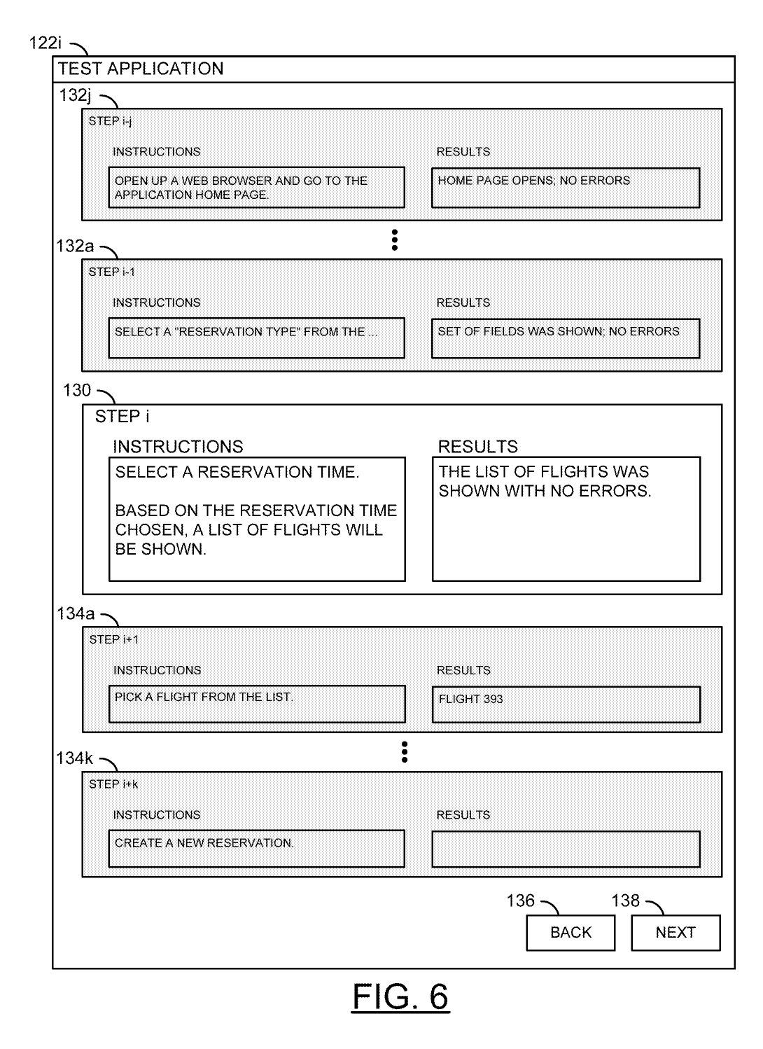

Referring to FIG. 6, a diagram is shown illustrating a generalized example of the dialog box 122i. In one example, the dialog box 122i may be configured to show a number (e.g., j) of previous items (e.g., boxes 132a-132j) and a number (e.g., k) of next items (e.g., boxes 134a-134k). The values j and k may be the same or different. In one example, the values j and k may be programmable. In general, clicking anywhere in the boxes 132a and 134a may have the same effect as clicking the “Back” or “Next” buttons (e.g., depending on the box that was clicked). In addition, clicking anywhere in the other inactive area boxes (e.g., 132b-132j and 134b-134k) may move to a dialog box of the help utility 116 for a corresponding step of the application 114.

In one example, the boxes 132a-132j may present the same instructions that appeared in the box 130 along with the user input received. In another example, the boxes 132a-132j may be configured to show less of the instructions than was presented in the box 130 (e.g., to save space). For example, the boxes 132a-132j may show abbreviated instructions similar to those appearing in the grid form presented by the application 114. The detail presented by each of the boxes 132a-132j may be varied. For example, more detail may be shown for the immediately preceding item, while less detail is shown for an item a few steps before the current item. The amount of detail presented in the boxes 134a-134k may be configured similarly to the boxes 132a-132j. In one example, the amount of detail may be programmable. For example, a user input may be used to configure the detail presented.

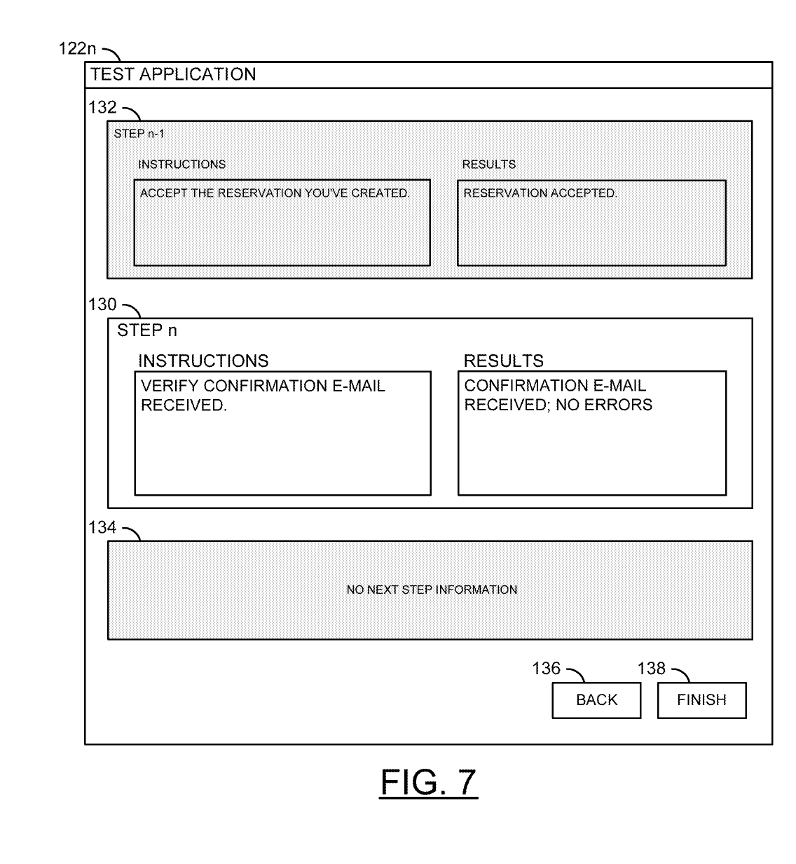

Referring to FIG. 7, a diagram is shown illustrating an example final dialog box 122n of a sequence of n dialog boxes presented by the help utility 116. In one example, the box 132 may show the instructions for the preceding step (e.g., Step n−1), and the results entered by the user. The box 134 may indicate that there is no next step information because the dialog box 122n is the final step of the test process. The dialog box 122n may include “Back” and “Next” buttons. In one example, the “Next” button 138 may be changed to read “Finish”, “End”, etc. Selecting (e.g., clicking on, etc.) the box 138 may, for example, terminate the help utility 116.

An application help utility (or wizard) in accordance with an example embodiment of the present invention may (i) allow a user to see past and future information while in the help utility, (ii) allow multiple ways to move forward and backward in the help utility, (iii) allow a user progressing through a wizard-like interface to see both the data that has been entered on the previous page, as well as the upcoming data that is yet to be entered or modified. An example embodiment of the present invention generally provides a mechanism where the steps immediately before and immediately after the current step are shown in a ghosted manner in the help utility dialog box. However, other adaptations of the idea may be implemented. For example, the help utility may be configured to show more than one previous and/or more than one following steps. For example, a help utility dialog box may show the previous two steps, and the next two steps. The steps that were two steps away from the current step may be ghosted in a manner that makes the steps stand out less than the steps one step away from the current step (e.g., the steps one away from current step may be greyed out slightly, while the steps two steps away may be greyed out more).

The functions illustrated by the diagrams of FIGS. 3-7 may be implemented using one or more of a conventional general purpose processor, digital computer, microprocessor, microcontroller, RISC (reduced instruction set computer) processor, CISC (complex instruction set computer) processor, SMID (single instruction multiple data) processor, signal processor, central processing unit (CPU), arithmetic logic unit (ALU), video digital signal processor (VDSP) and/or similar computational machines, programmed according to the teachings of the present specification, as will be apparent to those skilled in the relevant art(s). Appropriate software, firmware, coding, routines, instructions, opcodes, microcode, and/or program modules may readily be prepared by skilled programmers based on the teachings of the present disclosure, as will also be apparent to those skilled in the relevant art(s). The software is generally executed from a medium or several media by one or more of the processors of the machine implementation.

The present invention may also be implemented by the preparation of ASICs (application specific integrated circuits), Platform ASICs, FPGAs (field programmable gate arrays), PLDs (programmable logic devices), CPLDs (complex programmable logic device), sea-of-gates, RFICs (radio frequency integrated circuits), ASSPs (application specific standard products) or by interconnecting an appropriate network of conventional component circuits, as is described herein, modifications of which will be readily apparent to those skilled in the art(s).

The present invention thus may also include a computer product which may be a storage medium or media and/or a transmission medium or media including instructions which may be used to program a machine to perform one or more processes or methods in accordance with the present invention. Execution of instructions contained in the computer product by the machine, along with operations of surrounding circuitry, may transform input data into one or more files on the storage medium and/or one or more output signals representative of a physical object or substance, such as an audio and/or visual depiction. The storage medium may include, but is not limited to, any type of disk including floppy disk, hard drive, magnetic disk, optical disk, CD-ROM, DVD and magneto-optical disks and circuits such as ROMs (read-only memories), RAMs (random access memories), EPROMs (electronically programmable ROMs), EEPROMs (electronically erasable ROMs), UVPROM (ultra-violet erasable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, storage and/or playback devices, video recording, storage and/or playback devices, game platforms, peripherals and/or multi-chip modules. Those skilled in the relevant art(s) would understand that the elements of the invention may be implemented in other types of devices to meet the criteria of a particular application.

As would be apparent to those skilled in the relevant art(s), the paths illustrated in FIG. 1 represent logical data flows. The logical data flows are generally representative of physical data transferred between the respective blocks by, for example, address, data, and control signals, and/or busses. The system represented by the circuit 100 may be implemented in hardware, software or a combination of hardware and software according to the teachings of the present disclosure, as would be apparent to those skilled in the relevant art(s).

While the invention has been particularly shown and described with reference to the preferred embodiments thereof, it will be understood by those skilled in the art that various changes in form and details may be made without departing from the scope of the invention.

1. A method of using a help utility user interface to facilitate data entry into a software application, comprising:
receiving via the help utility user interface a first user input relating to a data field of the application software, wherein the help utility user interface presents an active data field for receiving said first user input for a current item, a first inactive field representing a previous item and a second inactive field representing a subsequent item;
storing the first user input in a data cell associated with the data field of the application software corresponding with the current item; and
receiving via the help utility user interface a second user input related to moving to another item.

2. The method according to claim 1, wherein the first inactive field presents a number of prior items and the second inactive field presents a number of subsequent items.

3. The method according to claim 2, wherein the number of prior items and the number of subsequent items displayed are the same.

4. The method according to claim 2, wherein the number of prior items and the number of subsequent items displayed are different.

5. The method according to claim 2, wherein the number of prior items and the number of subsequent items displayed are programmable.

6. The method according to claim 1, wherein the original application displays data fields to be entered as a list.

7. The method according to claim 1, wherein the original application displays data fields to be entered as a grid.

8. The method according to claim 1, wherein the help utility user interface further comprises a pair of navigation buttons, the second user input comprises a user selecting one of the buttons and the help utility user interface moves between pages in response to the button selected.

9. The method according to claim 8, wherein the help utility user interface is further configured to move between the pages in response to the user clicking in one of the inactive fields representing the previous and the subsequent items.

10. The method according to claim 1, wherein the help utility user interface displays the inactive fields representing the previous and the subsequent items as ghosted boxes.

11. An apparatus including a help utility user interface comprising a sequence of interface pages configured to facilitate data entry into a software application, comprising:
page logic associated with an initial user interface page, wherein the page logic is configured to receive via the help utility user interface a first user input relating to a data field of the application software, the help utility user interface presenting an active data field for receiving said first user input for a current item, a first inactive field representing a previous item and a second inactive field representing a subsequent item;
a storage medium configured to store the first user input in a data cell associated with the data field of the application software corresponding with the current item; and
navigation logic configured to move to another item in response to a second user input received via the help utility user interface.

12. The apparatus according to claim 11, wherein the first inactive field presents a number of prior items and the second inactive field presents a number of subsequent items.

13. The apparatus according to claim 12, wherein the number of prior items and the number of subsequent items displayed are the same.

14. The apparatus according to claim 12, wherein the number of prior items and the number of subsequent items displayed are different.

15. The apparatus according to claim 12, wherein the number of prior items and the number of subsequent items displayed are programmable.

16. The apparatus according to claim 11, wherein the original application displays data fields to be entered as a list.

17. The apparatus according to claim 11, wherein the original application displays data fields to be entered as a grid.

18. The apparatus according to claim 11, wherein the help utility user interface further comprises a pair of navigation buttons, the second user input comprises a user selecting one of the buttons and the help utility user interface moves between pages in response to the button selected.

19. The apparatus according to claim 18, wherein the help utility user interface is further configured to move between the pages in response to the user clicking on one of the inactive fields representing the previous and the subsequent items.

20. A computer readable medium containing processor executable instructions configured to perform the steps of:
receiving via a help utility user interface a first user input relating to a data field of an application software, wherein the help utility user interface presents an active data field for receiving said first user input for a current item, one or more first inactive fields representing one or more previous items and one or more second inactive fields representing one or more subsequent items;
storing the first user input in a data cell associated with the current data field of the application software corresponding with the current item; and
receiving via the help utility user interface a second user input related to moving to another item.
